(19) United States
(12) Patent Application Publication
(10) Pub. No.: US 2023/0393851 A1
(43) Pub. Date: Dec. 7, 2023

(54) PROCESSING SYSTEM WITH INTEGRATED DOMAIN SPECIFIC ACCELERATORS

(71) Applicant: Alibaba Group Holding Limited, Georgetown (KY)

(72) Inventors: Yuhao WANG, Sunnyvale, CA (US); Zhaoyang DU, Zhejiang (CN); Yen-kuang CHEN, Palo Alto (CA); Wei HAN, Sunnyvale, CA (US); Shuangchen LI, Sunnyvale, CA (US); Fei XUE, Sunnyvale, CA (US); Hongzhong ZHENG, Los Gatos, CA (US)

(21) Appl. No.: 18/212,128

(22) Filed: Jun. 20, 2023

Related U.S. Application Data
(63) Continuation of application No. PCT/CN2020/138277, filed on Dec. 22, 2020.

(51) Int. Cl. G06F 9/30; G06F 9/38

(52) U.S. Cl. CPC G06F 9/30196; G06F 9/3877

(57) ABSTRACT

A number of domain specific accelerators (DSA1-DSAn) are integrated into a conventional processing system (100) to operate on the same chip by adding additional instructions to a conventional instruction set architecture (ISA), and further adding an accelerator interface unit (130) to the processing system (100) to respond to the additional instructions and interact with the DSAs.

This application is a continuation of and claims the benefit of and priority to co-pending PCT Application PCT/CN2020/138277 entitled “Processing System with Integrated Domain Specific Accelerators” filed on Dec. 22, 2020, which is incorporated herein by reference.

### TECHNICAL FIELD

The present application relates to the field of processing systems and, in particular, to a processing system with integrated domain specific accelerators.

### BACKGROUND ART

An accelerator is a device that has been designed to handle a specific computationally intensive task. The main processor of a processing system commonly off loads these computing tasks to an accelerator, which thereby allows the main processor to continue with other tasks. Probably the most well-known accelerator, due to its use with nearly all current-generation personal computers, is a graphics accelerator. There are, however, many different types of accelerators. Traditionally, an accelerator was coupled to and communicated with the main processor via an external bus, such as a peripheral component interconnect express (PCIe) bus. Recently, however, accelerators, known as domain specific accelerators (DSAs), and a processing system have been integrated together on the same chip.

However, integrating an accelerator and a processing system is a non-trivial task, partly because any changes to the instruction set architecture (ISA) that are made to accommodate the instructions required to operate a DSA with a processing system require substantial changes to the toolchain, which are the complex tools utilized to verify the correct operation of the processing system. Thus, there is a need for a simplified approach to integrating DSAs and a processing system onto the same chip.

### SUMMARY OF THE INVENTION

Efficient and effective acceleration and processing systems and methods are presented. In one embodiment, a novel simplified approach to integrating domain specific accelerators (DSAs) and a processing system onto the same chip is presented. In one exemplary implementation, the novel approach involves only minor modifications to the toolchain. In one embodiment, a system and method provides a processing system that includes a main processor that decodes a fetched instruction, and outputs an interface instruction in response to decoding the fetched instruction. The processing system also includes an accelerator interface unit that is coupled to the main processor. The accelerator interface unit includes a plurality of interface registers, and a receiver that is coupled to the main processor and the plurality of interface registers. The receiver to receive the interface instruction from the main processor, generate a command of a plurality of commands from the interface instruction, determine an identified interface register of the plurality of interface registers from the interface instruction, and output the command to the identified interface register. The identified interface register to execute the command output by the receiver. The processing system additionally includes a plurality of domain specific accelerators that are coupled to the plurality of interface registers. A domain specific accelerator of the plurality of domain specific accelerators to receive information from, and provide information to, the identified interface register.

In one embodiment, a method also includes operating an accelerator interface unit. The method includes receiving an interface instruction from a main processor, generating a command of a plurality of commands from the interface instruction, determining an identified interface register of a plurality of interface registers that are coupled to a plurality of domain specific accelerators from the interface instruction, and outputting the command to the identified interface register. The identified interface register to execute the command output by the receiver.

In one embodiment, a method further includes operating a processing system. The method includes decoding a fetched instruction with a main processor, and outputting an interface instruction in response to decoding the fetched instruction. The method also includes receiving the interface instruction from the main processor, generating a command of a plurality of commands from the interface instruction, determining an identified interface register of a plurality of interface registers that are coupled to a plurality of domain specific accelerators from the interface instruction, and outputting the command to the identified interface register. The identified interface register to execute the command output by the receiver.

A better understanding of the features and advantages of the present invention will be obtained by reference to the following detailed description and accompanying drawings which set forth an illustrative embodiment in which the principals of the invention are utilized. In order to provide a better description of the technical means of the present application so as to implement the present application according to the contents of the specification, and to make the above and other objectives, features, and advantages of the present application easier to understand, specific embodiments of the present application are given below.

### BRIEF DESCRIPTION OF THE DRAWINGS

Various other advantages and benefits will become apparent to those of ordinary skill in the art by reading the detailed description of the preferred embodiments in the following text. The drawings are only for the purpose of illustrating preferred embodiments and are not construed as limiting the present application. Moreover, the same reference symbols are used to indicate the same parts throughout the drawings. In the drawings:

FIG. 1 is a block diagram illustrating an example of a processing system 100 in accordance with one embodiment.

FIG. 2 is a flow chart illustrating an example of a method 200 of operating main processor 110 in accordance with one embodiment.

FIGS. 3A-3C are a flow chart illustrating an example of a method 300 of operating accelerator interface unit 130 in accordance with the one embodiment.

### DETAILED DESCRIPTION

Exemplary embodiments of the present disclosure will be described in more detail with reference to the drawings. Although the exemplary embodiments of the present disclosure are shown in the drawings, it should be understood that the present disclosure can be implemented in various forms and should not be limited by the embodiments set forth here. Instead, these embodiments are provided to offer a more thorough understanding of the present disclosure, and to fully communicate the scope of the present disclosure to those skilled in the art.

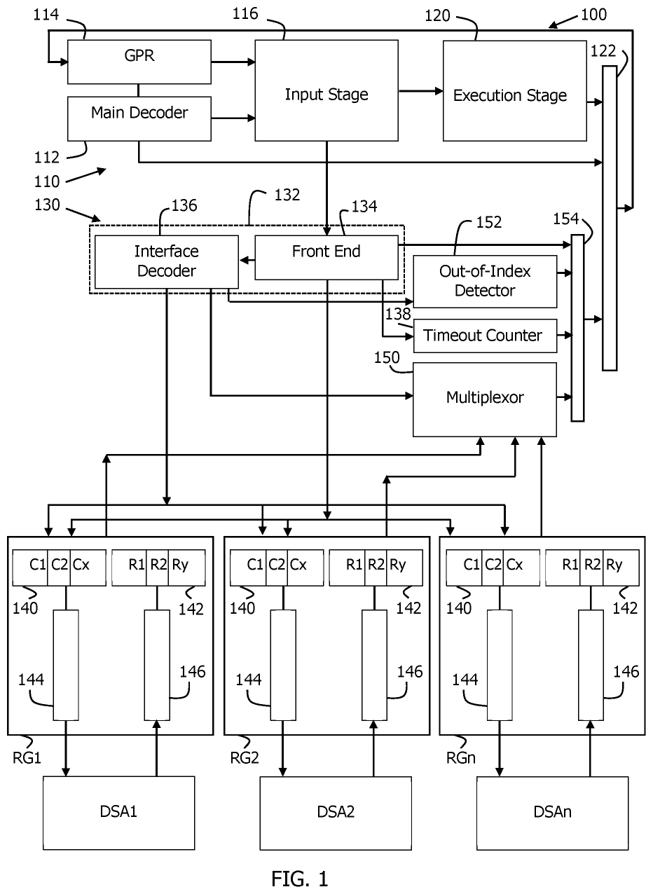

FIG. 1 shows a block diagram that illustrates an example of a processing system 100 in accordance one embodiment. As shown in FIG. 1, processing system 100 includes a main processor 110 that includes a main decoder 112, a multi-word GPR 114 that is coupled to main decoder 112, and an input stage 116 that is coupled to main decoder 112 and GPR 114. In addition, main processor 110 includes an execution stage 120 that is coupled to input stage 116, and a switch 122 that is coupled to main decoder 112, execution stage 120, and GPR 114.

As further shown in FIG. 1, processing system 100 also includes an accelerator interface unit 130 that is coupled to input stage 116 and switch 122 of main processor 110. Accelerator interface unit 130 includes a receiver 132 that is coupled to input stage 116, and a number of interface registers RG1-RGn that are coupled to receiver 132.

In operation, receiver 132 receives an interface instruction from main processor 110, which decodes a fetched instruction, and outputs the interface instruction to receiver 132 in response to decoding the fetched instruction. In one embodiment, receiver 132 does not fetch instructions in the same manner as decoder 112 of main processor 110, but instead receives an interface instruction only when the fetched instruction instructs main processor 100 to provide an interface instruction.

In addition, receiver 132 generates a command of a number of commands from the interface instruction, determines an identified interface register of the number of interface registers from the interface instruction, and outputs the command to the identified interface register, which responds to the command.

In the present example, receiver 132 includes a front end 134 that is coupled to input stage 116, an interface decoder 136 that is coupled to front end 134, and a timeout counter 138 that is coupled to front end 134. In addition, the interface registers RG1-RGn are each coupled to front end 134 and interface decoder 136. In operation, front end 134 receives the interface instruction from main processor 110, generates the command from the interface instruction, broadcasts the command to the interface registers RG, determines identifier information from the interface instruction, and outputs the identifier information. Interface decoder 136, in turn, determines the identified interface register from the identifier information, generates an enable signal, and outputs the enable signal to the identified interface register, which responds by executing the command broadcast by front end 134.

In one exemplary implementation, each of the interface registers RG has a command register 140 that has a number of 32-bit command memory locations C1-Cx, and a response register 142 that has a number of 32-bit response memory locations R1-Ry. Although the present example shows each command register 140 as having the same number of command memory locations Cx, the command registers 140 can alternately have different numbers of command memory locations C. Similarly, although the present example shows each response register 142 having the same number of response memory locations Ry, the response registers 142 can alternately have different numbers of response memory locations R.

Further, each of the interface registers RG has a first-in first-out (FIFO) output queue 144 that is coupled to command register 140, and a FIFO input queue 146 that is coupled to response register 142. In one embodiment, each line of FIFO output queue 144 has the same number of memory locations as the number of memory locations in command register 140. Similarly, each line in FIFO input queue 146 has the same number of memory locations as the number of memory locations in response register 142.

In one embodiment, accelerator interface unit 130 includes an output multiplexor 150 that is coupled to interface decoder 136 and each of the interface registers RG. Optionally, accelerator interface unit 130 can include an out-of-index detector 152 that is coupled to interface decoder 136. Further, accelerator interface unit 130 also includes a switch 154 that is coupled to front end 134, which selectively couples timeout counter 138, multiplexor 150, or out-of-index detector 152 (when utilized) to switch 122.

In the present example, main decoder 112, GPR 114, input stage 116, and execution stage 120 are substantially conventional elements commonly found in main processors, such as a RISC-V processor, and primarily differ to the extent necessary to provide an output from input stage 116 to accelerator interface unit 130. In a typical RISC-V processor, for example, the GPR has 32 memory locations, where each location is 32 bits long. In addition, execution stages typically include an arithmetic logic unit (ALU), a multiplier, and a load-store unit (LSU).

As further shown in FIG. 1, processing system 100 also includes a number of domain specific accelerators DSA1-DSAn that are coupled to the output and input queues 144 and 146 of the interface registers RG1-RGn. The domain specific accelerators DSA1-DSAn can be implemented with a variety of conventional accelerators, such as video, vision, artificial intelligence, vector, and general matrix multiply. In addition, the domain specific accelerators DSA1-DSAn can operate at any required clock frequency.

In operation, the domain specific accelerators DSA1-DSAn receive values from the output queues 144 of the corresponding interface registers RG1-RGn, interpret the values as opcodes and operands, perform an operation based on the opcodes and operands, and provide results of the operation back to the input queues 146 of the corresponding interface registers RG1-RGn.

As described in greater detail below, a number of new instructions, which include DSA-command write, push ready, push, read ready, pop, and read instructions, are added to a conventional instruction set architecture (ISA). For example, the RISC-V ISA has four basic instruction sets (RV321, RV32E, RV641, RV1281) and a number of extension instruction sets (e.g., M, A, F, D, G, Q, C, L, B, J, T, P, V, N, H) that can be added to a basic instruction set to achieve a particular goal. In this example, the RISC-V ISA is modified to include the new instructions in a custom extension set.

In addition, the new instructions utilize the same instruction format as the other instructions in the ISA. For example, the RISC-V ISA has six instruction formats. One of the six formats is an I-type format which has a seven-bit opcode field, a five-bit destination field that identifies a destination location in a general purpose register (GPR), a three-bit function field that identifies an operation to be performed, a five-bit operand field that identifies the location of a value in the GPR, and a 12-bit immediate field.

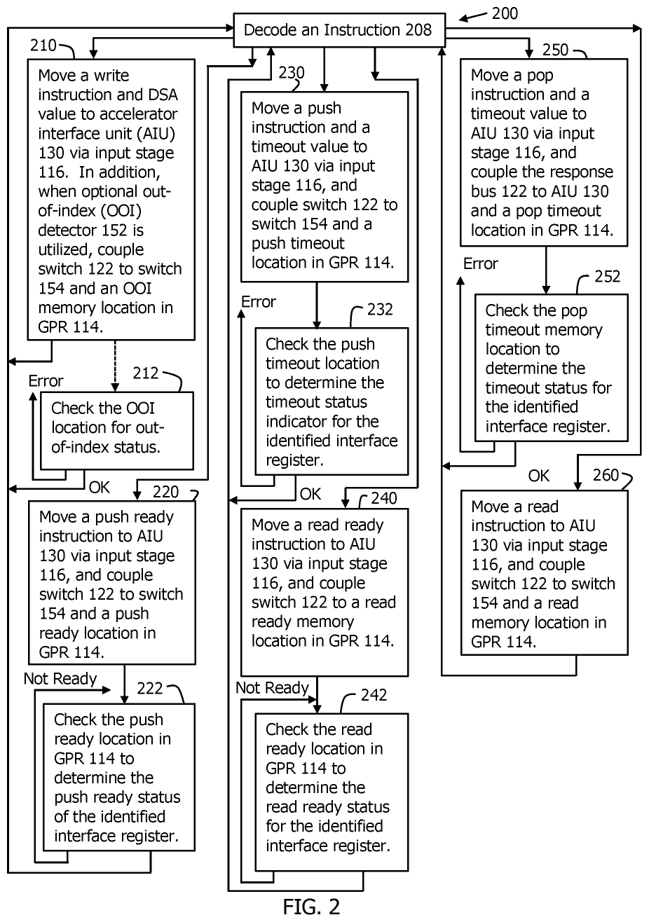

FIG. 2 shows a flow chart that illustrates an example of a method 200 of operating main processor 110 in accordance with one embodiment. As shown in FIG. 2, method 200 begins at 208 where main processor 110 decodes a fetched instruction, and outputs an interface instruction in response to decoding the fetched instruction.

In the present example, the fetched instruction executed by main processor 110 is an instruction from an instruction set architecture that includes novel instructions in accordance with one embodiment. In one exemplary implementation, the interface instruction, in turn, can be the same as the fetched instruction, include only selected fields from the fetched instruction, or include the information from the fetched instruction in a different format. In the present example, the interface instruction is the same as the fetched instruction.

Method 200 moves to 210 when a DSA-command write instruction of the new instructions is decoded by main decoder 112. The DSA-command write instruction includes an operand field that defines a memory location in GPR 114 that holds a DSA value, a function field that instructs accelerator interface unit 130 to perform a write operation, and an immediate field that identifies an interface register RG and a command memory location C within the command register 140 of the identified interface register RG. (The interface register RG and the command memory location C can alternately be in two separate fields.)

In addition, in the present example, the DSA-command write instruction further includes an opcode field that instructs main decoder 112 of main processor 110 to move the DSA-command write instruction and the DSA value held in the memory location in GPR 114 to accelerator interface unit 130 via input stage 116.

Further, when the optional out-of-index detector 152 is utilized, the DSA-command write instruction includes a destination field that identifies an out-of-index memory location in GPR 114, while the opcode field also instructs main decoder 112 to couple switch 122 to switch 154 and the out-of-index memory location in GPR 114.

For example, in the I-type format of a RISC-V instruction, the five-bit operand field can identify the location of the DSA value in GPR 114, the three-bit function field can identify the write operation to be performed by accelerator interface unit 130, and the 12-bit immediate field can hold an identifier of the interface register RG and an identifier of the command memory location C. The destination register field, in turn, can identify the out-of-index memory location.

In addition, the seven-bit opcode field of a RISC-V instruction can instruct main decoder 112 to move the DSA-command write instruction and the DSA value held in the memory location of GPR 114 to accelerator interface unit 130 via input stage 116, and when the optional out-of-index detector 152 is utilized, couple switch 122 to switch 154 and the out-of-index memory location in GPR 114.

The out-of-index memory location can hold an out-of-index status for the identified interface register. When the out-of-index detector 152 is not utilized, method 200 returns to 208. When the out-of-index detector 152 is utilized, method 200 moves to 212 to check the out-of-index memory location, returns to 208 when there is no out-of-index status condition, and generates an error when an out-of-index status condition is present.

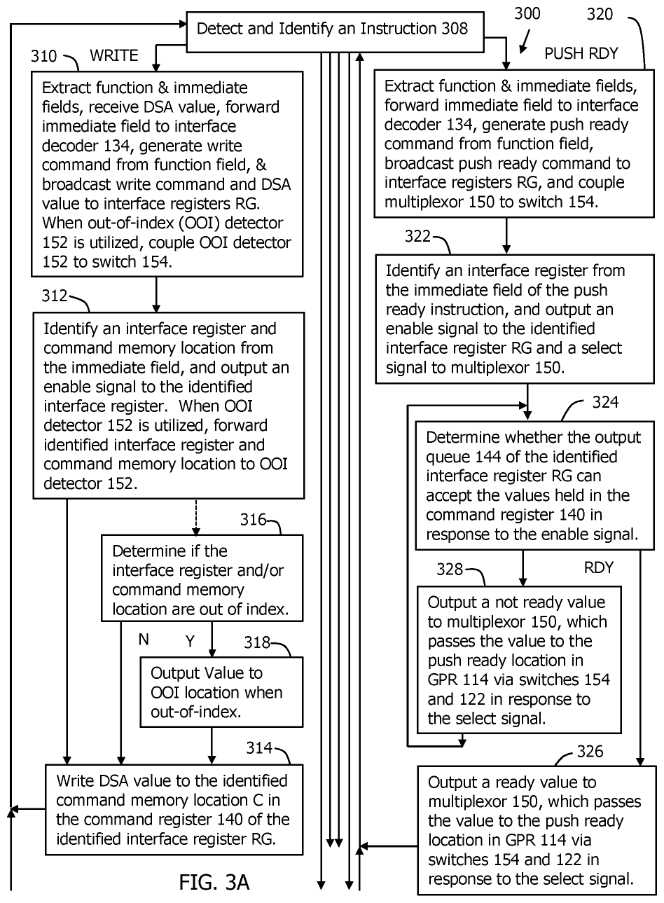

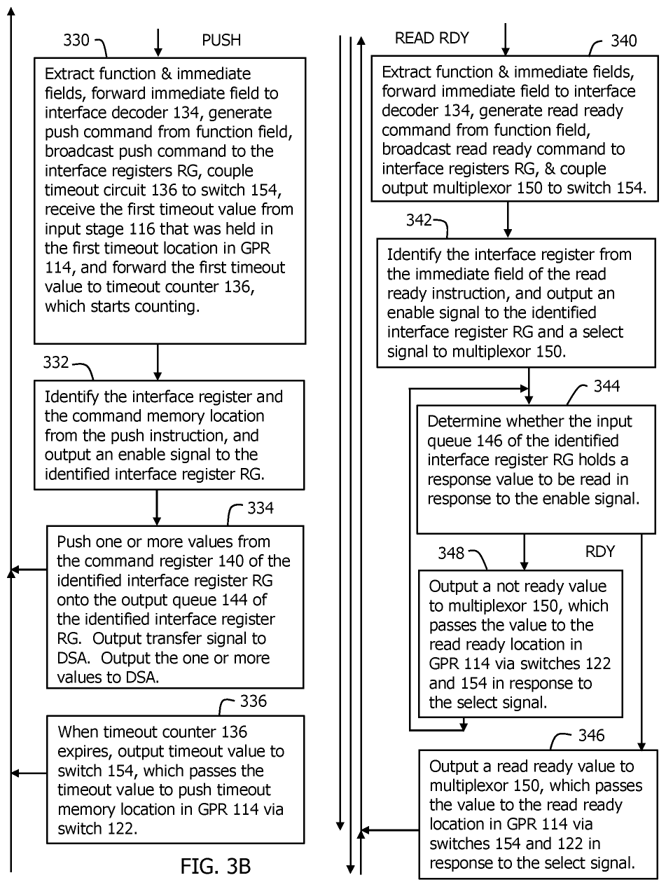

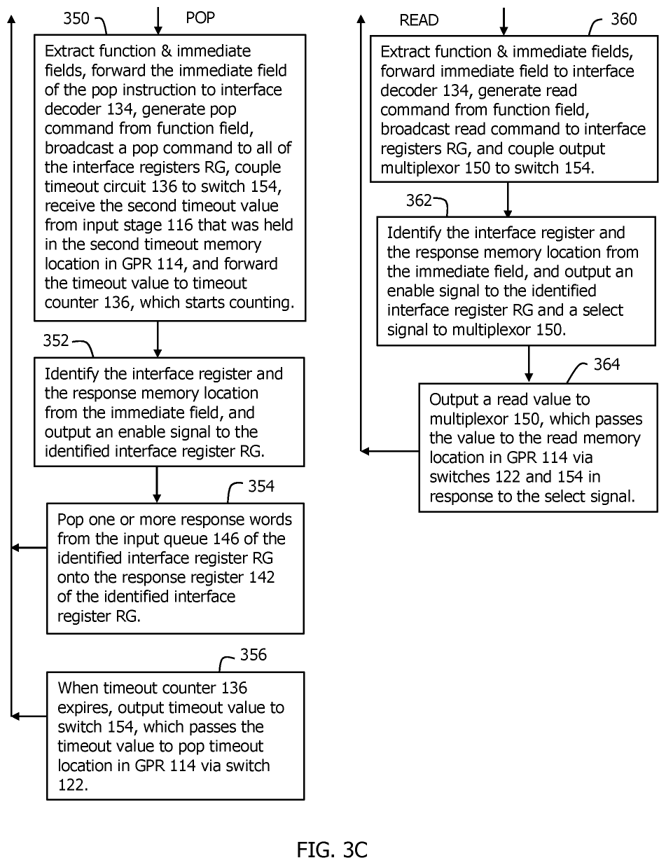

FIGS. 3A-3C show a flow chart that illustrates an example of a method 300 of operating accelerator interface unit 130 in accordance with one embodiment. As shown in FIG. 3A, method 300 begins at 308 where front end 134 of accelerator interface unit 130 detects and identifies the receipt of a DSA-command instruction from input stage 116.

When a DSA-command write instruction of the new instructions is identified, method 300 moves to 310 where front end 134 extracts the function field and the immediate field from the DSA-command write instruction. In addition, front end 134 receives the DSA value from input stage 116 that was held in the memory location in GPR 114.

Further, front end 134 forwards the immediate field to interface decoder 136, generates a write command from the function field, and broadcasts the write command and the DSA value to the interface registers RG. Further, when out-of-index detector 152 is utilized, front end 134 couples out-of-index detector 152 to switch 154.

Next, method 300 moves to 312 where interface decoder 136 identifies an interface register and a command memory location C of the command register 140 of the identified interface register RG from the immediate field of the DSA-command write instruction, and outputs a coded enable signal that indicates the identified interface register to the interface registers RG. In one embodiment, in lieu of a coded enable signal, a separate enable signal is optionally be sent to each interface register. In one exemplary implementation, a coded enable signal slightly increases the complexity of the interface registers RG, but reduces the number of traces. Following this, method 300 moves to 314 where the identified interface register RG, in response to recognizing the enable signal, writes the DSA value to the identified command memory location C of the command register 140 of the identified interface register RG.

When out-of-index detector 152 is utilized, method 300 moves from 312 to 316 to determine if the interface register and/or command memory location are out of index. For example, if there are three interface registers RG and the immediate field of the DSA-command write instruction identifies a fifth interface register, then out-of-index detector 152 detects an out-of-index condition. Similarly, if there are four command memory locations C1-C4 and the immediate field identifies a fifth command memory location, then out-of-index detector 152 detects an out-of-index condition.

When either or both are out of index, method 300 moves to 318 to output a value to the out-of-index memory location in GPR 114 via the switches 154 and 122. The out-of-index memory location can then be checked to determine if an error exists. When both are within index, method moves from 316 to 314 where the identified interface register RG writes the DSA value to the identified command memory location C in the command register 140 of the identified interface register RG in response to the enable signal. From 314, method 300 returns to 308 to wait for another instruction.

Referring again to FIG. 2, method 200 resumes at 208 where main decoder 112 decodes another fetched instruction, such as another DSA-command write instruction. In one embodiment, a write operation includes two or more DSA-command write instructions. The DSA value in GPR 114 that is identified by the operand field in one DSA-command write instruction represents a DSA opcode (the operation to be performed by a DSA), while the DSA value in GPR 114 that is identified by the operand field in another DSA-command write instruction represents a DSA operand (a value to be manipulated).

In one embodiment, main decoder 112 and front end 134 treat the DSA opcode and the DSA operand in the same way without being able to tell them apart, or needing to tell them apart. The DSA-command write instruction basically moves a word from GPR 114 to the command register 140 of an identified interface register RG.

Several DSA-command write instructions are utilized to fill the command memory locations C in command register 140. It is left up to the domain specific accelerator DSA that is coupled to the identified interface register RG to determine if a DSA value is a DSA opcode or a DSA operand, and the programmer to make sure the command register 140 is assembled correctly.

Alternately, in one embodiment, the DSA opcode and the DSA operand can be combined and stored together at a memory location in GPR 114. For example, a number of bits in a 32-bit memory location in GPR 114 can be assigned to represent a DSA opcode (the operation to be performed by the DSA), while the remaining bits can represent a DSA operand (a value to be manipulated on by the DSA).

Referring again to FIG. 2, when main decoder 112 decodes another DSA-command instruction of the new instructions, method 200 moves to 220 when a DSA-command push ready instruction is decoded. The DSA-command push ready instruction includes a function field that instructs accelerator interface unit 130 to perform a push ready operation, an immediate field that identifies an interface register RG, and a destination field that identifies a push ready memory location in GPR 114.

The DSA-command push ready instruction also includes an opcode field that instructs main decoder 112 to move the DSA-command push ready instruction to accelerator interface unit 130 via input stage 116, and to couple switch 122 to switch 154 and the push ready memory location in GPR 114. The push ready memory location holds a push ready status for the identified interface register.

For example, in the I-type format of a RISC-V instruction, the three-bit function field can identify the push ready operation to be performed by accelerator interface unit 130, while the 12-bit immediate field can hold the identifier of the interface register RG. The destination field, in turn, can hold the identity of the push ready memory location in GPR 114. In addition, the seven-bit opcode field can instruct main decoder 112 to move the DSA-command push ready instruction to accelerator interface unit 130 via input stage 116, and couple switch 122 to switch 154 and the push ready memory location in GPR 114.

Referring again to FIG. 3A, method 300 resumes at 308 where front end 134 of accelerator interface unit 130 detects and identifies the receipt of another interface instruction from input stage 116. When a DSA-command push ready instruction of the new instructions is identified, method 300 moves to 320 where front end 134 extracts the function field and the immediate field from the DSA-command push ready instruction.

In addition, front end 134 forwards the immediate field of the DSA-command push ready instruction to interface decoder 136, generates a push ready command from the function field, broadcasts the push ready command to the interface registers RG, and couples output multiplexor 150 to switch 154.

Next, method 300 moves to 322 where interface decoder 136 identifies the interface register from the immediate field of the DSA-command push ready instruction. Interface decoder 136 also outputs a select signal to multiplexor 150, and a coded enable signal that indicates the identified interface register to the interface registers RG. Following this, method 300 moves to 324 where the identified interface register RG, in response to recognizing the coded enable signal, determines whether the output queue 144 of the identified interface register RG can accept the values held in the command register 140.

When the output queue 144 of the identified interface register RG can accept the values held in the command register 140, method 300 moves to 326 where the identified interface register RG outputs a ready value to output multiplexor 150, which passes the ready value to the push ready location in GPR 114 via switches 154 and 122 in response to the select signal.

When the output queue 144 of the identified interface register RG is not ready to accept the values, method 300 moves to 328 where the identified interface register RG outputs a not ready value to multiplexor 150, which passes the not value to the push ready location in GPR 114 via switches 122 and 154 in response to the select signal, and then loops until a ready signal has been output. Alternately, the loop can also include additional steps. Method 300 returns to 308 after a ready value has been output to wait for a next instruction.

Referring again to FIG. 2, method 200 moves from 220 to 222 to check the push ready memory location in GPR 114 to determine the push ready status for the identified interface register. Method 200 loops until the push ready status indicates that the identified interface register is ready to accept a push command. Alternately, the loop can also include additional steps. When the push ready status indicates ready, method 200 returns to 208 where main decoder 112 decodes another fetched instruction.

Method 200 moves to 230 when a DSA-command push instruction of the new instructions is decoded. The DSA-command push instruction includes a timeout field that defines a first timeout memory location in GPR 114 that holds a first timeout value, a function field that instructs accelerator interface unit 130 to perform a push operation, an immediate field that identifies an interface register RG and a command memory location C in the command register 140 of the identified interface register RG, and a destination field that identifies a push timeout memory location in GPR 114.

In addition, the DSA-command push instruction includes an opcode field that instructs main decoder 112 to move the DSA-command push instruction and the first timeout value held in the first timeout memory location in GPR 114 to accelerator interface unit 130 via input stage 116, and couple switch 122 to switch 154 and the push timeout memory location in GPR 114. The push timeout memory location holds a first timeout status.

For example, in the I-type format of a RISC-V instruction, the five-bit operand field can identify the first timeout memory location of the first timeout value in GPR 114, the three-bit function field can identify the push operation to be performed by accelerator interface unit 130, and the 12-bit immediate field can hold the identifiers of the interface register RG and the command memory location C. The destination register field, in turn, can identify the push timeout memory location. In addition, the seven-bit opcode field can instruct main decoder 112 to move the DSA-command push instruction and the first timeout value held in the first timeout memory location to accelerator interface unit 130 via input stage 116, and couple switch 122 to switch 154 and the push timeout memory location in GPR 114.

Referring to FIGS. 3A-3B, method 300 resumes at 308 where front end 134 of accelerator interface unit 130 detects and identifies the receipt of another interface instruction from input stage 116. When a DSA-command push instruction of the new instructions is identified, method 300 moves to 330 where front end 134 extracts the function field and the immediate field from the DSA-command push instruction.

In addition, front end 134 forwards the immediate field of the DSA-command push instruction to interface decoder 136, generates a push command from the function field, and broadcasts the push command to the interface registers RG. In addition, front end 134 receives the first timeout value from input stage 116 that was held in the first timeout memory location in GPR 114, couples timeout circuit 138 to switch 154, and forwards the first timeout value to timeout counter 138, which starts counting.

Next, method 300 moves to 332 where interface decoder 136 identifies an interface register RG and a command memory location C from the intermediate field of the DSA-command push instruction, and outputs a coded enable signal that indicates the identified interface register to the interface registers RG.

Following this, method 300 moves to 334 where the identified interface register RG, in response to recognizing the coded enable signal, pushes one or more values from the identified command memory location(s) C in the command register 140 of the identified interface register RG onto the output queue 144 of the identified interface register RG.

In addition, the identified interface register RG outputs a transfer signal to the corresponding domain specific accelerator DSA indicating that one or more values are in the output queue 144 and ready to be transferred. The transfer signal can be a notification signal to the corresponding domain specific accelerator DSA, or an acknowledgement to a query from the corresponding domain specific accelerator DSA.

Following this, the identified interface register RG transfers the value to the corresponding domain specific accelerator DSA utilizing any conventional handshake protocol. Once the associated DSA has received the required opcodes and operands, the DSA performs the required tasks and returns a response value to the input queue 146 of the identified interface register RG in a manner similar to how values were received from the output queue 144.

In addition, method 300 moves to 336 when timeout counter 138 expires, where timeout counter 138 outputs a timeout value to switch 154, which passes the timeout value to the push timeout memory location in GPR 114 via switches 154 and 122.

Referring again to FIG. 2, method 200 moves from 230 to 232 to check the push timeout memory location in GPR 114 to determine the first timeout status for the identified interface register. When the first timeout status is set, the status indicates that an error has occurred. When the first timeout status is not set, method 200 returns to 208 to decode a next fetched instruction.

Method 200 moves from 208 to 240 when a DSA-command read ready instruction of the new instructions is decoded. The DSA-command read ready instruction includes a function field that instructs accelerator interface unit 130 to perform a read ready operation, an immediate field that identifies an interface register, and a destination field that identifies a read ready memory location in GPR 114.

The DSA-command read ready instruction also includes an opcode field that instructs main decoder 112 to move the DSA-command read ready instruction to accelerator interface unit 130 via input stage 116, and couple switch 122 to the read ready memory location in GPR 114. The read ready memory location holds a read ready status for the identified interface register.

For example, in the I-type format of a RISC-V instruction, the three-bit function field can identify the read ready operation to be performed by accelerator interface unit 130, while the 12-bit immediate field can hold the register identifier. The destination register field, in turn, can identify the read ready memory location. In addition, the seven-bit opcode field can instruct main decoder 112 to move the DSA-command read ready instruction to accelerator interface unit 130 via input stage 116, and couple switch 122 to switch 154 and to the read ready location in GPR 114.

Referring again to FIGS. 3A-3B, method 300 resumes at 308 where front end 134 of accelerator interface unit 130 detects and identifies the receipt of another instruction from input stage 116. When a DSA-command read ready instruction of the new instructions is identified, method 300 moves to 340 where front end 134 extracts the function field and the immediate field from the DSA-command read ready instruction. In addition, front end 134 forwards the immediate field of the DSA-command read ready instruction to interface decoder 136, generates a read ready command from the function field, broadcasts the read ready command to the interface registers RG, and couples output multiplexor 150 to switch 154.

Next, method 300 moves to 342 where interface decoder 136 identifies the interface register RG from the immediate field of the DSA-command read ready instruction. Interface decoder 136 also outputs a select signal to multiplexor 150, and a coded enable signal that indicates the identified interface register to the interface registers RG. Following this, method 300 moves to 344 where the identified interface register RG, in response to recognizing the enable signal, determines whether the input queue 146 of the identified interface register RG holds a response value to be read that was received from the corresponding domain specific accelerator DSA.

When the input queue 146 of the identified interface register RG holds a value to be read, method 300 moves to 346 where the identified interface register RG outputs a read ready value to output multiplexor 150, which passes the read ready value to the read ready memory location in GPR 114 via switches 154 and 122 in response to the select signal.

When the input queue 146 of the identified interface register RG is empty, method 300 moves to 348 where the identified interface register RG outputs a not ready value to multiplexor 150, which passes the not ready value to the read ready memory location in GPR 114 via switches 154 and 122 in response to the select signal, and then loops until a read ready value has been output. Alternately, the loop can also include additional steps. Method 300 returns to 308 after a read ready value has been output to wait for a next instruction.

Referring again to FIG. 2, method 200 moves from 240 to 242 to check the read ready memory location in GPR 114 to determine the read ready status for the identified interface register. Method 200 loops until the read ready status indicates that input queue 146 of the identified interface register RG holds a value to be read. Alternately, the loop can also include additional steps.

Following this, method 200 returns to 208 to decode a next fetched instruction. Method 200 moves to 250 when a DSA-command pop instruction of the new instructions is decoded. The DSA-command pop instruction includes a timeout field that defines a second timeout memory location in GPR 114 that holds a second timeout value, a function field that instructs accelerator interface unit 130 to perform a pop operation, an immediate field that identifies an interface register RG and a response memory location R, and a destination field that identifies a pop timeout memory location in GPR 114.

In addition, the DSA-command pop instruction includes an opcode field that instructs main decoder 112 to move the DSA-command pop instruction and the second timeout value held in the second timeout memory location in GPR 114 to accelerator interface unit 130 via input stage 116, and to couple switch 122 to switch 154 and the pop timeout memory location in GPR 114. The pop timeout memory location holds a second timeout status.

For example, in the I-type format of a RISC-V instruction, the five-bit operand field can identify the second timeout memory location of the second timeout value in GPR 114, the three-bit function field can identify the pop operation to be performed by accelerator interface unit 130, and the 12-bit immediate field can identify an interface register RG and a response memory location R in the response register 142 of the identified interface register RG. The destination register field, in turn, can identify the pop timeout memory location. In addition, the seven-bit opcode field can instruct main decoder 112 to move the DSA-command pop instruction and the second timeout value held in the second timeout memory location in GPR 114 to accelerator interface unit 130 via input stage 116.

Referring to FIGS. 3A-3C, method 300 resumes at 308 where front end 134 of accelerator interface unit 130 detects and identifies the receipt of another interface instruction from input stage 116. When a DSA-command pop instruction of the new instructions is identified, method 300 moves to 350 where front end 134 extracts the function field and the immediate field from the DSA-command pop instruction.

In addition, front end 134 forwards the immediate field of the DSA-command pop instruction to interface decoder 136, generates a pop command from the function field, and broadcasts the pop command to the interface registers RG. In addition, front end 134 receives the second timeout value from input stage 116 that was held in the second timeout memory location in GPR 114, couples timeout circuit 138 to switch 154, and forwards the second timeout value to timeout counter 138, which starts counting.

Next, method 300 moves to 352 where interface decoder 136 identifies an interface register and a response memory location R from the immediate field of the DSA-command pop instruction, and outputs a coded enable signal that indicates the identified interface register to the interface registers RG. Following this, method 300 moves to 354 where the identified interface register RG, in response to receiving the coded enable signal, pops one or more response words from the input queue 146 of the identified interface register RG into one or more response memory locations R in the response register 142 of the identified interface register RG.

In addition, method 300 moves to 356 when timeout counter 138 expires, where timeout counter 138 outputs a second timeout value to switch 154, which passes the timeout value to the pop timeout memory location in GPR 114 via switch 122.

Referring again to FIG. 2, method 200 moves from 250 to 252 to check the pop timeout memory location to determine a second timeout status for the identified interface register. When the second timeout status is set, the status indicates that an error has occurred. When the second timeout status is not set, method 200 returns to 208 to decode a next fetched instruction.

Method 200 moves from 208 to 260 when a DSA-command read instruction of the new instructions is decoded. The DSA-command read instruction includes a function field that instructs accelerator interface unit 130 to perform a read operation, an immediate field that identifies an interface register RG and a response memory location R in the response register 142 of the identified interface register RG, and a destination field that identifies a read memory location in GPR 114.

Further, the DSA-command read instruction includes an opcode field that instructs main decoder 112 to move the DSA-command read instruction to accelerator interface unit 130 via input stage 116, and couple switch 122 to switch 154 and the read memory location in GPR 114. For example, in the I-type format of a RISC-V instruction, the three-bit function field can identify the read operation to be performed by accelerator interface unit 130, and the 12-bit immediate field can identify the interface register RG and the response memory location R in the response register 142 of the identified interface register RG.

The destination register field, in turn, can identify the read memory location. In addition, the seven-bit opcode field can instruct main decoder 112 to move the DSA-command read instruction to accelerator interface unit 130 via input stage 116, and couple switch 122 to switch 154 and the read memory location in GPR 114. The read memory location in GPR 114 holds the value returned from the DSA.

Referring again to FIGS. 3A-3C, method 300 resumes at 308 where front end 134 of accelerator interface unit 130 detects and identifies the receipt of another interface instruction from input stage 116. When a DSA-command read instruction of the new instructions is identified, method 300 moves to 360 to extract the function field and the immediate field from the DSA-command read instruction. In addition, front end 134 forwards the immediate field of the DSA-command read instruction to interface decoder 136, generates a read command from the function field, and broadcasts the read command to the interface registers RG. In addition, front end 134 couples output multiplexor 150 to switch 154.

Next, method 300 moves to 362 where interface decoder 136 identifies an interface register and a response memory location R from the immediate field of the DSA-command read instruction. In addition, interface decoder 136 outputs a select signal to output multiplexor 150, and a coded enable signal that indicates the identified interface register to the interface registers RG.

Following this, method 300 moves to 364 where the identified interface register RG, in response to recognizing the enable signal, passes a response word from the response memory location R to output multiplexor 150, which passes the response word R to switch 122 in response to the select signal. The response word then passes through switch 122 to the read memory location in GPR 114.

The present invention provides a number of advantages. One of the biggest advantages is that the new instructions are generic and thereby only require minor modifications to an existing toolchain when compared to other approaches, such as a multiple-input multiple output (MIMO) approach or an ISA extension that utilizes specific instructions. In addition, interaction latency, computation scalability, and multi-accelerator collaboration are good. In addition, programmability granularity is also fine.

Reference has now been made in detail to the various embodiments of the present disclosure, examples of which are illustrated in the accompanying drawings. While described in conjunction with the various embodiments, it will be understood that these various embodiments are not intended to limit the present disclosure. On the contrary, the present disclosure is intended to cover alternatives, modifications and equivalents, which may be included within the scope of the present disclosure as construed according to the claims. Furthermore, in the preceding detailed description of various embodiments of the present disclosure, numerous specific details are set forth in order to provide a thorough understanding of the present disclosure. However, it will be recognized by one of ordinary skill in the art that the present disclosure may be practiced without these specific details or with equivalents thereof. In other instances, well-known methods, procedures, components, and circuits have not been described in detail so as not to unnecessarily obscure aspects of various embodiments of the present disclosure.

It is noted that although a method may be depicted herein as a sequence of numbered operations for clarity, the numbering does not necessarily dictate the order of the operations. It should be understood that some of the operations may be skipped, performed in parallel, or performed without the requirement of maintaining a strict order of sequence. The drawings showing various embodiments in accordance with the present disclosure are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the various embodiments in accordance with the present disclosure can be operated in any orientation.

Some portions of the detailed descriptions are presented in terms of procedures, logic blocks, processing, and other symbolic representations of operations on data bits within a computer memory. These descriptions and representations are used by those skilled in the data processing arts to effectively convey the substance of their work to others skilled in the art. In the present disclosure, a procedure, logic block, process, or the like, is conceived to be a self-consistent sequence of operations or instructions leading to a desired result.

The operations are those utilizing physical manipulations of physical quantities. Usually, although not necessarily, these quantities take the form of electrical or magnetic signals capable of being stored, transferred, combined, compared, and otherwise manipulated in a computing system. It has proven convenient at times, principally for reasons of common usage, to refer to these signals as transactions, bits, values, elements, symbols, characters, samples, pixels, or the like.

It should be borne in mind, however, that these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “generating,” “determining,” “assigning,” “aggregating,” “utilizing,” “virtualizing,” “processing,” “accessing,” “executing,” “storing,” or the like, refer to the action and processes of a computer system, or similar electronic computing device or processor. The computing system, or similar electronic computing device or processor manipulates and transforms data represented as physical (electronic) quantities within the computer system memories, registers, other such information storage, and/or other computer readable media into other data similarly represented as physical quantities within the computer system memories or registers or other such information storage, transmission or display devices.

The technical solutions in the embodiments of the present application have been clearly and completely described in the prior sections with reference to the drawings of the embodiments of the present application. It should be noted that the terms “first,” “second,” and the like in the description and claims of the present invention and in the above drawings are used to distinguish similar objects and are not necessarily used to describe a specific sequence or order. It should be understood that these numbers may be interchanged where appropriate so that the embodiments of the present invention described herein can be implemented in orders other than those illustrated or described herein.

The functions described in the method of the present embodiment, if implemented in the form of a software functional unit and sold or used as a standalone product, can be stored in a computing device readable storage medium.

Based on such understanding, a portion of the embodiments of the present application that contributes to the prior art or a portion of the technical solution may be embodied in the form of a software product stored in a storage medium, including a plurality of instructions for causing a computing device (which may be a personal computer, a server, a mobile computing device, or a network device, and so on) to perform all or part of the steps of the methods described in various embodiments of the present application. The foregoing storage medium includes: a USB drive, a portable hard disk, a read-only memory (ROM), a random-access memory (RAM), a magnetic disk, an optical disk, and the like, which can store program code.

The various embodiments in the specification of the present application are described in a progressive manner, and each embodiment focuses on its difference from other embodiments, and the same or similar parts between the various embodiments may be referred to another case. The described embodiments are only a part of the embodiments, rather than all of the embodiments of the present application. All other embodiments obtained by a person of ordinary skill in the art based on the embodiments of the present application without departing from the inventive skills are within the scope of the present application.

The above description of the disclosed embodiments enables a person skilled in the art to make or use the present application. Various modifications to these embodiments are obvious to a person skilled in the art, and the general principles defined herein may be implemented in other embodiments without departing from the spirit or scope of the present application. Therefore, the present application is not limited to the embodiments shown herein, but the broadest scope consistent with the principles and novel features disclosed herein.

What is claimed is:

1. A processing system comprising:
a main processor that decodes a fetched instruction, and outputs an interface instruction in response to decoding the fetched instruction;
an accelerator interface unit coupled to the main processor, the accelerator interface unit including:
a plurality of interface registers; and
a receiver coupled to the main processor and the plurality of interface registers, the receiver to receive the interface instruction from the main processor, generate a command that is one of a plurality of commands from the interface instruction, determine an identified interface register of the plurality of interface registers from the interface instruction, and output the command to the identified interface register, the identified interface register to execute the command output by the receiver; and
a plurality of domain specific accelerators coupled to the plurality of interface registers, a domain specific accelerator of the plurality of domain specific accelerators to receive information from the identified interface register, and provide information to the identified interface register.

2. The processing system of claim 1, wherein an interface register included in the plurality of interface registers comprises:
a command register that has a number of command memory locations;
an output queue coupled to the command register and a domain specific accelerator of the plurality of domain specific accelerators;
a response register that has a number of response memory locations; and
an input queue coupled to the response register and the domain specific accelerator.

3. The processing system of claim 1, wherein the main processor includes:
a main decoder that decodes the fetched instruction;
a general-purpose register coupled to the main decoder;
an input stage coupled to the main decoder, the general-purpose register, and a front end of the receiver; and
an execution stage coupled to the input stage.

4. The processing system of claim 1, wherein the receiver includes:
a front end coupled to the main processor, the front end to receive the interface instruction from the main processor, generate the command from the interface instruction, broadcast the command to the plurality of interface registers, determine identifier information from the interface instruction, and output the identifier information; and
an interface decoder coupled to the front end, the interface decoder to determine the identified interface register from the identifier information, generate an enable signal, and output the enable signal to the identified interface register.

5. The processing system of claim 4, wherein when the interface instruction is a write instruction:
the front end to generate a write command of the plurality of commands from the interface instruction, receive a value from the main processor in addition to the interface instruction, broadcast the write command and the value to the plurality of interface registers; and
the identified interface register writes the value into the command register of the identified interface register in response to the enable signal.

6. The processing system of claim 4, wherein the accelerator interface unit further includes a multiplexor coupled to the interface decoder and the plurality of interface registers.

7. The processing system of claim 1, wherein when the interface instruction is a push ready instruction:
a front end included in the receiver, the front end to generate a push ready command of a plurality of commands from the interface instruction, and broadcast the push ready command to the plurality of interface registers;
an interface decoder included in the reliever, the interface decoder to output a select signal in addition to the enable signal in response to determining the identified interface register;
a command register included in the identified interface register to determine whether an output queue of the identified interface register can accept a value stored in the command register in response to the enable signal, output a ready value to a multiplexor of the accelerator interface unit when the output queue of the identified interface register can accept the value stored in the command register, and output a not ready value to the multiplexor when the output queue of the identified interface register cannot accept the value stored in the command register; and
the multiplexor to pass the ready signal or the not ready signal in response to the select signal.

8. The processing system of claim 7, wherein when the interface instruction is a push instruction:
the front end to generate a push command of the plurality of commands from the interface instruction, and broadcast the push command to the plurality of interface registers; and
the identified interface register to push the value stored in the command register into the output queue in response to the enable signal.

9. The processing system of claim 1, wherein when the interface instruction is a read ready instruction:
a front end included in the receiver, the front end to generate a read ready command of the plurality of commands from the interface instruction, and broadcast the read ready command to the plurality of interface registers;
an interface decoder included in the reliever, the interface decoder to output a select signal in addition to the enable signal in response to determining the identified interface register;
the identified interface register to determine whether an input queue of the identified interface register holds a response value from the domain specific accelerator, output a ready value to a multiplexor of the accelerator when the input queue of the identified interface register holds a response value, and output a not ready value to the multiplexor when the input queue of the identified interface register does not hold a response value; and
the multiplexor to pass the ready signal or the not ready signal in response to the select signal.

10. The processing system of claim 9, wherein when the interface instruction is a pop instruction:
the front end to generate a pop command of the plurality of commands from the interface instruction, and broadcast the pop command to the plurality of interface registers; and
the identified interface register to pop the response value in the input queue from the domain specific accelerator into the response register of the identified interface register in response to the enable signal.

11. The processing system of claim 10, wherein when the interface instruction is a read instruction:
the front end to generate a read command of the plurality of commands from the interface instruction, and broadcast the read command to the plurality of interface registers;
the interface decoder to output the select signal in addition to the enable signal in response to determining the identified interface register;
the identified interface register to output the response value held in the response register to the multiplexor in response to the enable signal; and
the multiplexor to pass the response value in response to the select signal.

12. A method of operating an accelerator interface unit, the method comprising:
receiving an interface instruction from a main processor;
generating a command of a plurality of commands from the interface instruction;
determining an identified interface register of a plurality of interface registers that are coupled to a plurality of domain specific accelerators from the interface instruction; and
outputting the command to the identified interface register, the identified interface register to execute the command output by the receiver.

13. The method of claim 12, wherein:
determining an identified interface register includes:
determining identifier information from the interface instruction;
determining the identified interface register from the identifier information;
generating an enable signal, and outputting the enable signal to the identified interface register; and
outputting the command to the identified interface register includes broadcasting the command to the plurality of interface registers.

14. The method of claim 12, further comprising when the interface instruction is a write instruction:
generating a write command of the plurality of commands from the interface instruction;
receiving a value from the main processor in addition to the interface instruction;
broadcasting the write command and the value to the plurality of interface registers; and
writing the value into a command register in response to the enable signal.

15. The method of claim 14, further comprising when the interface instruction is a push ready instruction:
generating a push ready command of the plurality of commands from the interface instruction, and broadcasting the push ready command to the plurality of interface registers;
outputting a select signal in addition to the enable signal in response to determining the identified interface register;
determining whether the output queue of the identified interface register can accept the value stored in the command register in response to the enable signal, outputting a ready value when the output queue of the identified interface register can accept the value stored in the command register, and outputting a not ready value when the output queue of the identified interface register cannot accept the value stored in the command register; and
passing the ready signal or the not ready signal in response to the select signal.

16. The method of claim 14, further comprising when the interface instruction is a push instruction:
generating a push command of the plurality of commands from the interface instruction, and broadcasting the push command to the plurality of interface registers;
outputting a select signal in addition to the enable signal in response to determining the identified interface register; and
pushing the value stored in the command register into an output queue in response to the enable signal.

17. The method of claim 12, wherein when the interface instruction is a read ready instruction:
generating a read ready command of the plurality of commands from the interface instruction, and broadcasting the read ready command to the plurality of interface registers in response to the read ready instruction;
outputting a select signal in addition to the enable signal in response to determining the identified interface register;
determining whether an input queue of an interface register holds a response value from a domain specific accelerator, outputting a ready value when the input queue of the identified interface register holds a response value, and outputting a not ready value when the input queue of the identified interface register does not hold a response value; and
passing the ready signal or the not ready signal in response to the select signal.

18. The method of claim 17, wherein when the interface instruction is a pop instruction:
generating a pop command of the plurality of commands from the interface instruction, and broadcasting the pop command to the plurality of interface registers in response to the pop instruction; and
popping a response value from a domain specific accelerator into a response register of the identified interface register in response to the enable signal.

19. The method of claim 18, wherein when the interface instruction is a read instruction:
generating a read command of the plurality of commands from the interface instruction, and broadcasting the read command to the plurality of interface registers in response to the read instruction;
outputting a select signal in addition to the enable signal in response to determining the identified interface register;
outputting the response value held in the response register in response to the enable signal; and
passing the response value in response to the select signal.

20. A method of operating a processing system, the method comprising:
decoding a fetched instruction with a main processor;
outputting an interface instruction in response to decoding the fetched instruction;
receiving the interface instruction from the main processor;
generating a command of a plurality of commands from the interface instruction;
determining an identified interface register of a plurality of interface registers that are coupled to a plurality of domain specific accelerators from the interface instruction; and
outputting the command to the identified interface register, the identified interface register to execute the command output by the receiver.
